(19) United States
(12) Patent Application Publication
(10) Pub. No.: US 2015/0002915 A1
(43) Pub. Date: Jan. 1, 2015

(54) Method for Scanning and Processing Documents

(71) Applicant: Ali Lebaschi, San Diego, CA (US)

(72) Inventor: Ali Lebaschi, San Diego, CA (US)

(21) Appl. No.: 13/928,076

(22) Filed: Jun. 26, 2013

(51) Int. Cl. H04N 1/56; G06F 17/30

(52) U.S. Cl. CPC H04N 1/56; G06F 17/30011
USPC 358/538

(57) ABSTRACT

An adaptive and selective scanning method, particularly for identifying and authenticating identification cards, is disclosed herein. The present invention evolved from a trend of more intricate security features configured to modern ID cards motivating more sophisticated counterfeits. These intricate features would typically require higher resolution (therefore large electronic files) and increased scanning times that would be unworkable in many environments where scan time is very important, such as airport security. Essentially, the method comprises multiple timely passes where specific target data is obtained. Initial ID card passes are concentrated to magnetic strip, as well as one and two dimensional barcode information. Subsequent card passes are focused to high resolution images of a specific portion of the card thereby reducing scan time.

### BACKGROUND OF THE INVENTION

1. Field of the Invention

The disclosed method relates to adaptive scanning and processing of images and multiple forms of coded and imprinted data from a document or an Identification Document (ID) card. More particularly, the invention pertains to a novel method identifying a type of document or ID card, dynamically configuring the scanning method to adaptively and selectively capture images, as well as coded and imprinted data from document or ID card, and processing the data either on a local processor or at a remote server.

2. Description of the Prior Art

In recent times, there has been an increase in security measures adopted by government and private agencies due to forgery, identity thefts, terrorism etc. As a result, there is continued need for business and government security personnel to inspect the identification cards of employees and citizens to verify identity and to ascertain their authenticity and scope. Further, bars, nightclubs and liquor stores that serve alcohol risk hefty fines and loss of their liquor licenses should they serve alcohol or tobacco to underage customers.

There are a few types of identification card readers in the market with the ability to scan and capture images or codes and imprinted data and use the information, for instance, for authentication. The two common types of these scanners are the contact scanner and camera type. In general, all available scanners achieve a similar result but in a different form factor. The goal of all these scanners is to capture an image of the identification document (ID) under a single or multi color light source. Typically, the scanning hardware uses light sources under white, infrared and ultraviolet wavelengths. Each one of these light sources can reveal one feature or another embedded into the document or the identification card. For example, scanning an ID card under UV light will energize the UV sensitive ink on the ID card and reveal a pattern that is not visible to a naked eye. Likewise, other light sources can be used to reveal other specific features embossed on a surface of a document.

Moreover, the white light source in these card readers is used for more than one purpose. First, the White light is used to capture the true color image for visible inspection and archiving. Second, this light is used to look at some of the physical features on the card that are unique and difficult to counterfeit. These physical features detection include microprint detection, original color detection, background pattern recognition, Optical Character Recognition (OCR) of the printed text, bar code encoding and more.

Further, ID card readers are available in a single or duplex scanning format. In a single sided scanner, only one side of document is scanned at a time. Thus, in order to scan both sides of document or card, the operator needs to follow a sequence of operations. The required procedure makes these single sided scanners less favorable for use, especially if the end user operates it. The duplex (motorized) scanners, that allow automatic scanning of documents on both sides, are more user-friendly. These duplex scanners that capture all light sources on both sides of document are in great demand. One such duplex document scanner is present assignee, E-SEEK's M500 product, described and claimed in U.S. Pat. No. 8,181,872.

In addition to the ease of operability by the end user, the speed and responsiveness of the duplex scanning system is very appealing. Many high traffic applications require the system to scan, process and display the results as fast as possible. So, every second saved in an operation multiplied by the number of scans per day could add up to a big time saving and less operating cost.

In modern society, there is at least one card used in various activities occurring almost daily. Each of these cards may be used for purpose of confirming the identity of the cardholder. As noted, identification documents or cards can direct to personal information about the cardholder stored in databases or servers. Also, private and government agencies employ different physical features on ID documents or cards. For instance, Department of Motor Vehicles of each state have different security features employed on the surface of driver licenses. Training of security personnel about the various security features and indicia employed on driver licenses of each state would be very expensive and time consuming. Still further, it is not possible for security personnel to remember and locate such features via human eye or even under various light sources. Therefore, there would not be any guarantee about the manual validation or inspection performed by such personnel. Also, individuals intent on manufacturing, forging, and/or use of false documents or ID cards are technologically advanced, and accordingly make use of highly sophisticated printers which enable them to print cards with features very similar to the original ID cards. Such highly sophisticated printers make it almost impossible to detect the hidden patterns or features through the human eye. In fact, the light sources normally used in scanners also fail to illuminate these hidden patterns or features. Thus, with an increase in usage of a variety of ID documents resulting in an increase of private or security information contained in these documents, there is a need for scanning systems and methods which can validate such documents only after processing the hidden features (e.g. microprints) that are very difficult to forge and not visible through human eye or under any light source.

Also, scanners that are currently available in the market typically conduct a pre-determined scan which increases time, power consumption and cost of the entire procedure. In today's high-tech world, there further remains a need for a scanning system and method that allows programmed scanning of documents, either in advance or during the procedure. Additionally, the scanning procedure should allow the government and private security personnel to scan the hidden features or patterns in highest resolution which would give them a better image to work with. At the same time, such system should be able to capture and process the highest resolution image contemporaneously and utilizing minimum computing power.

Accordingly as stated, there remains an unmet need for a scanning system and method that identifies a type of card being processed and also allows flexibility in further scanning the identified card thereby reducing superfluous scanning time. Unlike typical scanners that do not identify a card type but merely scans and leaves it up to the end user to decide further processing, the scanning method of the present invention adapts to the application environment and selectively scans as per the process configured or modified by the processor.

Also accordingly, it is an object of this invention to provide a scanning method capable of reading and identifying any type of document, including applicable issuing agency, thereby facilitating the further processing of the document by personnel lacking expertise or significant information about the document.

It further an additional object of this invention to provide a scanning method which allows the processor to selectively process or determine nature and quantity of scans in the middle of the scanning procedure thereby reducing the cost and superfluous scanning time.

Yet still it is an additional object of this invention to provide a scanning method enabling the processor to establish number of times a document should be mechanically translated through the document scanner in order to identify and selectively process the document.

### SUMMARY OF THE INVENTION

The disclosed adaptive scanning system and method herein employs processing electronically captured images and multiple forms of coded and imprinted data from one or both sides of a document to identify the type of document, and to further determine selective additional scans on the document that could be configured for further processing of selective images and multiple forms of coded and imprinted data from the document. In order to determine the selective additional scans, a configuration data stored on a local processor or available at a remote server assists in configuring the selective scanning method and thereby collects selective images from the document. The selective images collected from these additional scans are processed on the local processor or at the remote server.

The adaptive and selective scanning method disclosed herein is capable of scanning any document in multi-color format in a scanning device and further provides for an adaptive and selective scanning along with highest resolution images of the document inserted into a scanning device.

The adaptive method of scanning as disclosed and claimed herein is a very resourceful, swift, and effective method capable of identifying any type of document such as driver's license, identification cards, other identification documents like employment card, passport, health insurance card or credit cards and contrasting such documents with data compiled in a processor, and thereafter selectively scanning the document based upon the configured data transmitted via the processor.

Employing software and a novel mechanism adapted to electronically capturing the data imprinted on a surface of the document and initial processing the recorded data in a processor to determine the type of document thereby allows the end user to perform the scan without any expertise or experience about the documents to be processed. The end user, therefore, can identify and complete the scanning method without knowing what type of document it is before initiating the scan. Under the adaptive scanning method as described herein, the scanning device can read any data or and record any image imprinted on any ID card and that data or image would be sufficient for identification of that ID card.

Arranging the scanning device with a local processor or server at a remote place still allows for a scanning system with a very small footprint and can therefore be employed at inspection stations or entries where space is limited.

The adaptive scanning method has the ability to capture and read 2D or 1D bar codes that are frequently encoded on such identification documents and can also read encoded magnetic strip data.

The adaptive scanning method for reading and processing a document is further characterized by the method step of electronically recording one or more specifically recognized features of the document inserted which only appears visible under a specific light source (e.g specific wavelength).

Still further in a preferred method, the document scanner initiates transferring of recorded data to a processor for initial processing while further scanning the document or card. During this initial processing, the processor is programmed to locate any barcode imprinted on the document. The recorded electronic data along with barcode data, if any, is electronically processed in the processor, which includes decoding of bar code or employing a pattern recognition method to determine the type of document. This method assigns each input value to a given set of classes thereby identifying type of document. Thus, the scanning method described in the present invention is capable of reading and identifying any types of ID.

As an additional method step, the now identified document is referenced against configuration data stored in the processor. The configuration data represents the generic information and security features specifically associated with the identified document. This configuration data may include generic information including sets of pre-existing patterns similar to the indicia embossed on ID documents. For instance, the processor could have a configured database or template of pre-existing patterns like logos, images, drawings, hidden or micro indicia or information about texts, dimension of pictures or images employed on various types of ID documents or cards. Such configured database or template of pre-existing patterns could also be available in server connected over network or interne. The examples listed here are demonstrative only and the invention is not limited to only these generic data.

The purpose of contrasting identified document against the configured data is to extract information and any physical or security features to focus upon in the document under review. Based on the type of document and any physical or security features employed in such type of documents generated from the configured database, the processor will further define a set of additional tasks or scans to be performed during subsequent translation of the document though the document scanner. This configured data regarding the physical or security features associated with the identified document is communicated to the document scanner for selective processing of the document under review.

As noted, the adaptive and selective scanning method is capable of processing the document mechanically inserted into the document scanner. The processing of document further includes examining, or validating document under review for authentication or archiving purposes. The adaptive scanning method allows for manual or automatic programming of the document scanner for additional scans determined by referencing the recorded electronic data from the document against the generic or configuration data in the processor.

Further in the method herein, the processor could order to use the light sources that may illuminate the informational indicia as well as discern hidden authentication indicia being employed on such documents. In other words, hidden indicia may only be verified under a specific wavelength of light and such would be automatically revealed following a first pass identifying the document. Furthermore, such adaptive and selective scanning method also allows scanning of the identification document or card in highest resolution for only those indicia that could enable the processor to inspect and thereby immediately process the ID document or card. Under the adaptive and selective scanning method, the end user can have as many scans of document as per requirement of end result without increasing the cost of the procedure or impacting the computing time. Also, the document scanner is programmable to vary resolution of each scan captured during additional pass, and it is reprogrammable after each scan is completed.

As a result of the selective scanning method disclosed by the present invention, the end user could either store this scanned data for archiving purposes, or use this data for examination or authentication of the ID card and the holder presenting the card. Alternatively, data may be manually processed and communication communicated by the scanning device for any of the purpose listed aforementioned and related to the card under review.

The adaptive scanning method further provides for optionally creating a compressed image of the document scanned and transmitting the same to the processor for electronic processing in the future, if desired. In addition, the electronic data recorded during the initial pass and the selective images obtained during a subsequent pass may also be converted into compressed images. Such compressed images could be stored in the processor and may be used for archiving purposes, investigation, or verification in the future.

In the event a processor determines that no selective scanning is required and/or where no electronic data is recorded during initial pass, a default scanning method may be employed.

Also according to the invention, the processor used in this invention could be external or internal with respect to the scanning device. When the processor is connected externally to the scanning device, it could be a computing device situated locally or a server at a remote place. The server further includes a network server connected over local network or the interne, file server, database server, and the like. The scanning system may also use a high speed computer in places wherein network connectivity is not available for the use of cloud server. When configured internal to the scanner, the processor may be wired or wirelessly connected, and such processor could be a microprocessor, smart phone, finger-operable touchpad, etc.

In addition to the processor plus memory, the document scanner is employed with means for communicating with a network using either wireless or wired ports. Also, power can be supplied by on-board batteries or by an AC adapter.

In an additional preferred embodiment, the adaptive scanning method for reading and processing a document comprises the step of recording electronic data from the surface of said document in a document scanner on an initial pass; transferring electronic data recorded on said initial pass to a processor; initial processing of transferred electronic data captured from said document in said processor to identify type of said document; and parsing said processed electronic data to a first configuration data stored in said processor to determine a second configuration data for selective processing of said document. The first configuration data could determine specific information from the electronic data such as place of issue, date, type and more.

The invention method is additionally characterized wherein the selective processing of the document comprises the steps of: transmitting said second configuration data from said processor to said document scanner to capture selective images for said document; automatically configuring said document scanner for capturing of selective images for said document in said document scanner during additional passes; transmitting said selectively captured images during said additional passes back to said processor, said processor further having software adapted to further process said document with said electronic data captured during said initial pass, and said selective images captured during said additional passes.

Optionally as further clarified herein, the initial pass may include translating the document through the document scanner in a first pass followed by a second pass in a reverse direction; or simply translating the document through the document scanner for one pass only.

Also more specifically, the additional pass during which selective images are captured from the document may include translating the document in one additional pass or two additional passes or three additional passes through the document scanner. In one embodiment, the additional pass may include translating the document through the document scanner during a third pass followed by a fourth pass in reverse direction. In still another embodiment, the additional pass may include translating the document in a third pass, followed by a fourth pass and a fifth pass. In yet still an additional embodiment, the additional pass may include translating the document only through a third pass.

In yet another aspect, the adaptive scanning method for reading and processing a document comprises the steps of: recording electronic data from a surface of said document in a document scanner on a first pass; scanning said document to read any additional electronic data during a second pass; transferring electronic data recorded on said first pass and said second pass to a processor; initial processing of transferred electronic data captured from said document in said processor to identify type of said document; and contrasting said processed electronic data with a first configuration data stored in said processor to determine a second configuration data for selective processing of said document.

More particularly, the selective processing of said document comprises the steps of: transmitting said second configuration data from said processor to said document scanner to capture selective images for said document; automatically configuring said document scanner for capturing of selective images for said document in said document scanner during a third pass and a fourth pass; transmitting said selectively captured images from said third pass and said fourth pass back to said processor; said processor further having software adapted to further process said document with said electronic data captured during said first and said second pass, and said selective images captured during said third pass and said fourth pass.

More specifically during the first pass through the document scanner, the magnetic strip reader in the document scanner scans the magnetic strip present on the document and captures the magnetic data. During the second pass through the document scanner, a first image of a surface of said document is captured while illuminated with a first light. From the first image, the document scanner extracts a barcode containing electronic information regarding the ID document.

The method herein further provides that the (document scanner) image recording may simultaneously capture both sides of the document, and the document scanner may even capture both sides of the document as a single image. Further, the document scanner may record images imprinted on only one side of the document in cases where magnetic strip or barcode is not present on the said document, and the same could be recorded in one pass only.

During a third and/or a fourth pass, the document scanner is automatically configured to selectively scan the document as per the configured additional scan. In this aspect, the document scanner may be programmed to operate in IR light on third pass followed by scan of half of the document in UV light and a specific location of the document in resolution up to 1200 DPI on fourth pass. If a scan of specific area or image under different light source is required in further processing the document, such scan may be captured during a fifth pass.

In another aspect of this invention, if a specific area of the card is selected for scanning, such area could be specifically targeted and compressed in size before sending it to the processor for archival purposes and subsequent later processing.

Also according to the preferred method, in the event the processor is not able to configure any data for selective scanning, the document scanner operates in a default sequence wherein the document is scanned under one light source during the third pass followed by illumination under a same or different light source during the fourth pass. Specifically in yet another aspect of this invention, when the document scanner does not receive any configuration data from the processor for selective scanning following first and second passes, the document may still be scanned for additional images wherein the document is illuminated with IR light during third pass. Additionally, the document is further scanned under UV light wherein an image is captured during fourth pass.

In still another aspect, the invention may be characterized as an adaptive scanning system configured to scan an identification card for a selective area under a variety of light sources, the said adaptive scanning system comprising: a document scanner; a processor; and a communication link allowing transmission of scanned data for processing thereby identifying and authenticating the document. The document scanner is additionally characterized as programmable to capture images imprinted on the identification card in a mere one pass; and it is further programmable to vary resolution of each scan of said selective area. Also the scanner is characterized as reprogrammable after completion of each scan.

In still another aspect, the invention is an adaptive scanning method for reading and processing a document comprising the following steps: capturing electronic data from a surface of said document in a document scanner on an initial pass (the action is to capture the electronic data by scanning the surface of the card, capturing the magnetic data, capturing image of the bar code, capturing the image of text for (optical character recognition) OCR process); initial processing of the electronic data recorded on said initial pass to a processor (the initial processing is to convert bar code image to ASCII data, or convert binary magnetic data to a ASCII characters, or convert an OCR image to a text, for example).

An Additional method steps is the parsing of said processed electronic data to a first configuration data stored in said processor to determine a second configuration data for selective processing of said document.

At this point in the method, the stream of ASCII data is parsed into a known fields such as license number, name, date of birth, or address (etc.). The parsing (analyzing and organizing) can be done via bar code data, magnetic strip data as well as OCR which forms the first configuration data. From this first configuration data the method determines what type of ID card has been provided and which second configuration data will be needed. For example, if the first configuration data determines that the ID is California issued in year 2013, then a second configuration data corresponding to the issuing state and year determines which security features/types are incorporated thereto and specifically where they are located on the card. Accordingly, the second configuration data will further determine how many pass the scanner needs and which type of scans, including which light source, resolution, and speed.

More specifically, the method transmits the second configuration data from the processor to the document scanner, the second configuration data then determines a selective image on the document for subsequent scanning. Next the method automatically configures the document scanner for capturing of the selective image of said document in said document scanner during an additional pass; and transmitting the selective image/selective area during the additional pass back to the processor; the processor further having software adapted to further process the document using the electronic data captured during the initial pass, together with the selective image captured during said additional pass.

In yet still another aspect, the invention may be characterized as an adaptive scanning method for fast authentication of an identification card, the method comprising: determining the type of identification card presented to document scanner; targeting specifically a selective area (being smaller than the total surface area of the ID card); determining a configuration data to extract from the selective area for selective scanning; scanning the selective area using a specific light source, the specific light source depending on the configuration data in the selective area; and processing scanned data of said selective area to authenticate the ID card.

Practitioners of ordinary skill in the art will appreciate that the conception upon which the scanning method is based may readily be utilized as a basis for designing of other scanning processes for carrying out the several purposes of the present invention. It is important therefore that the claims be regarded as including such equivalent construction insofar as they do not depart from the spirit and scope of the invention.

These together with other objects and advantages which will become subsequently apparent and reside in the details of the method as more fully described and claimed, reference being had to the accompanying drawings forming a part thereof, wherein like numerals refer to like parts throughout.

### BRIEF DESCRIPTION OF THE DRAWINGS

The novel features of the invention, as well as the invention itself, both as to its structure and its operation will be best understood from the accompanying drawings, taken in conjunction with the accompanying description, in which similar reference characters refer to similar parts, and in which:

FIG. 1 is a depiction of document scanner showing the access slot to insert document or card;

FIG. 2 is a schematical depiction of scanner with a processor, a local computer or cloud server;

FIG. 3A and FIG. 3B illustrate top and underside views of an exemplary identification document showing areas where the electronic data and security or physical features might exist;

FIG. 4 depicts a functional flow chart of actual steps of an adaptive and selective scanning method;

FIG. 5 depicts a flow chart of default steps required if no information about additional scans is transmitted to document scanner; and

FIG. 6 is a flowchart of actual steps in an example for selective processing a document.

### DETAILED DESCRIPTION OF THE INVENTION

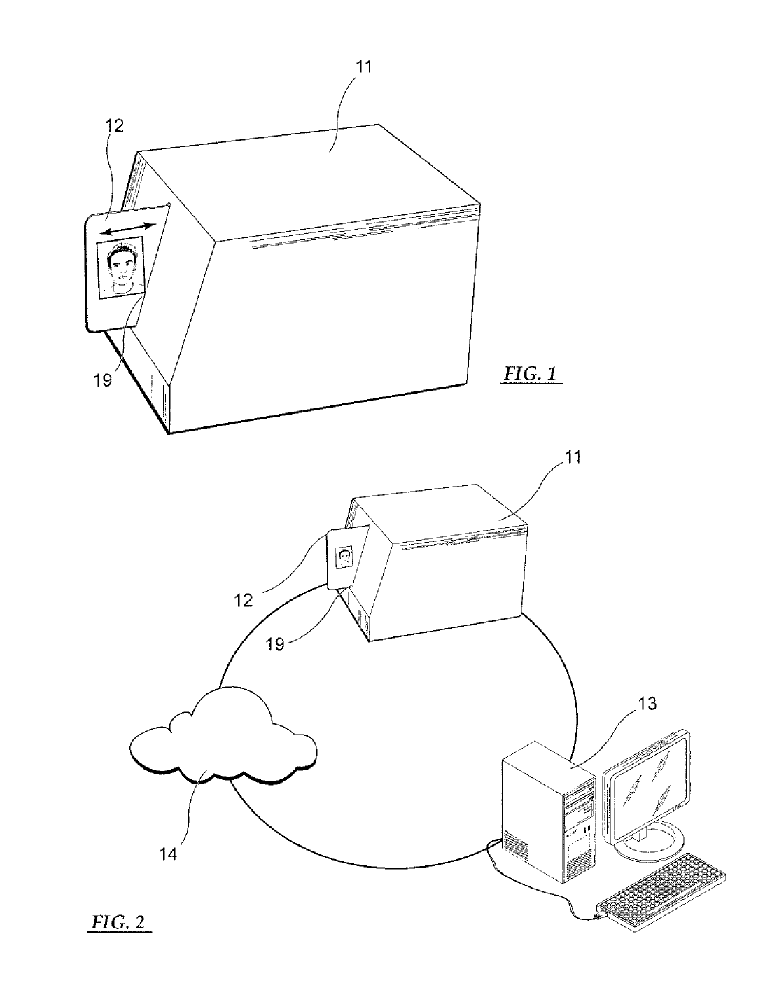

As shown in FIG. 1 and FIG. 2, the present invention is initially directed to a document scanner 11 according to a preferred embodiment invention includes any scanning device capable of being programmed for adaptive and selective scanning. The document scanner 11 is further capable of reading instructions received from a processor 13 as detailed herein. More particularly, the document scanner 11 employs software capable of reading multiple forms of coded and imprinted data as well as electronically recording images from a surface of the document 12 and transmitting the collected data and images to the processor whether located externally or on-board. The document scanner 11 may further include memory 13 to process the collected data, and communication links to receive and transmit data from the processor 13. Also with regard to FIG. 1 one embodiment shows a document scanner 11 incorporating front access 19 to insert the document or card 12. A user could alternatively insert or retrieve a card 12 from the front access 19. The document scanner 11 may also have a rear access to retrieve a card. Throughout the entire process, the document 12 is translated into and out of the document scanner 11 for duration or repetition sufficient to scan the document 12 under different light sources and capture the necessary segments of document into an electronic image showing the security indicia as additionally detailed herein. A speed at which the document 12 translates through the scanner 11 depends upon the type of scan programmed during the method. For instance, to record magnetic data from the magnetic strip 15, the document 12 will translate at a fast speed whereas slow speed is necessary to capture scan in resolution up to 1200 DPI.

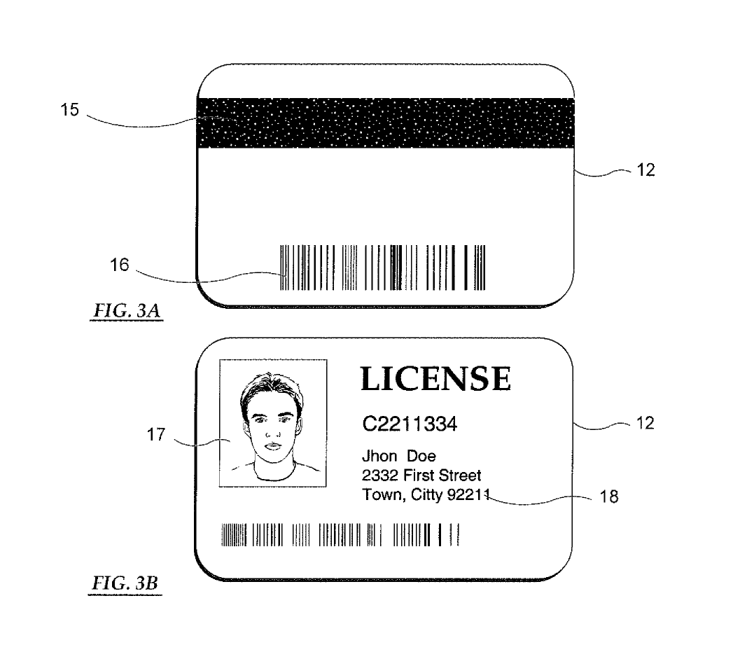

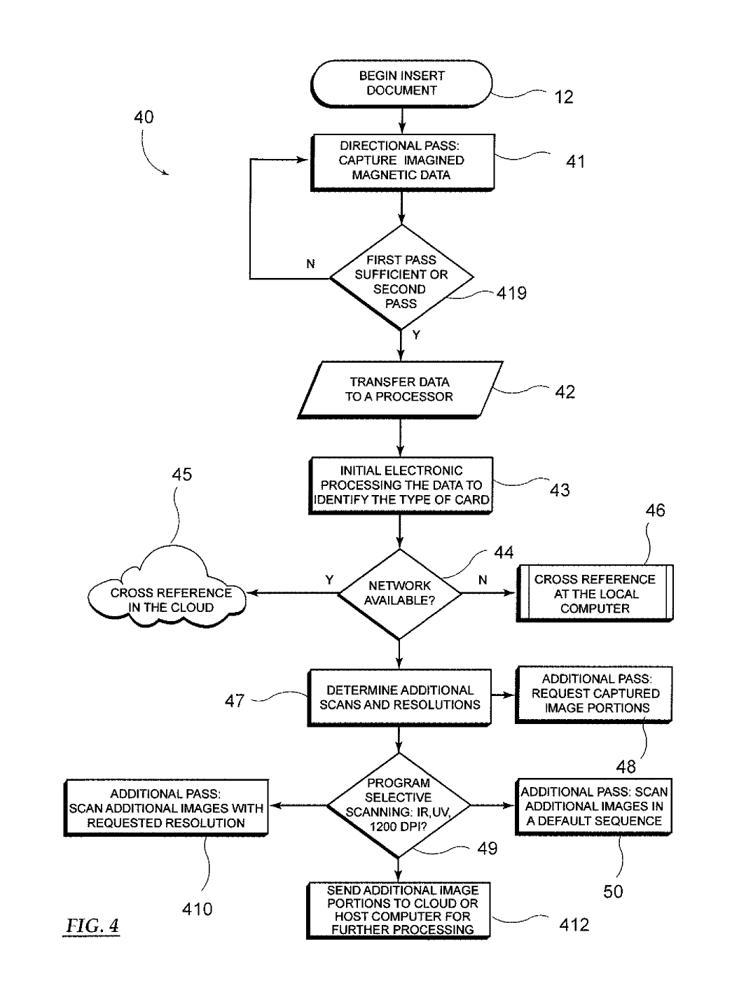

During the translation into and out of the scanner 11, images from both sides of a document (for e.g. driver's license or employment ID card and other double-sided document 12) are recorded in a so-called duplex scanner. It is preferred that both sides of the document as shown in FIGS. 3A and 3B are imaged concurrently. As noted, images from one side of the document 12 may also serve this purpose and reduce the speed of the entire process. Images from one side of the document 12 are captured in single sided scanners or if the duplex scanner fails to capture image from both sides concurrently. The concurrent capturing of images will allow for comparison of specific positions or points of indicia on both sides of the document in a quick and efficient manner.

Since each document 12 can have any number of hidden security features that are visible under certain light sources, the adaptive scanning method employs any scanning device 11 capable of capturing images of one or both sides of document 12, for e.g. card, or ID card under a number of different wavelengths of light or illumination sources sequentially. The sequential illumination for example includes: the visible spectrum (white light), specific visible frequencies (red, green, blue, etc.), ultraviolet light to illuminate holograms, or infrared light to determine paper or ink chemical composition. The light sources present in the document scanner 11 project light in sequential wavelengths or spectrums for example including UV (365 nm), Green (525 nm), Red (625 nm), IR (850 nm), and white. The wavelengths listed are demonstrative only and the document scanner 11 and the invention is not restricted to only those frequencies or those bands of light.

In addition to multiple light sources, it is preferred that the scanning device 11 employed in the adaptive scanning method described in the present invention, may comprise: an access 19 to insert and retrieve card, an imager, a lens, a plurality of strobing LEDs and reflective mirrors providing a linear flowpath for the document 12. It may further comprise a drive mechanism to mechanically translate a document 12 along the linear flowpath into and out of the document scanner 11. As noted, the document scanner 11 could be a single sided or duplex but a duplex scanner is preferred to extract maximum benefits from the claimed scanning method.

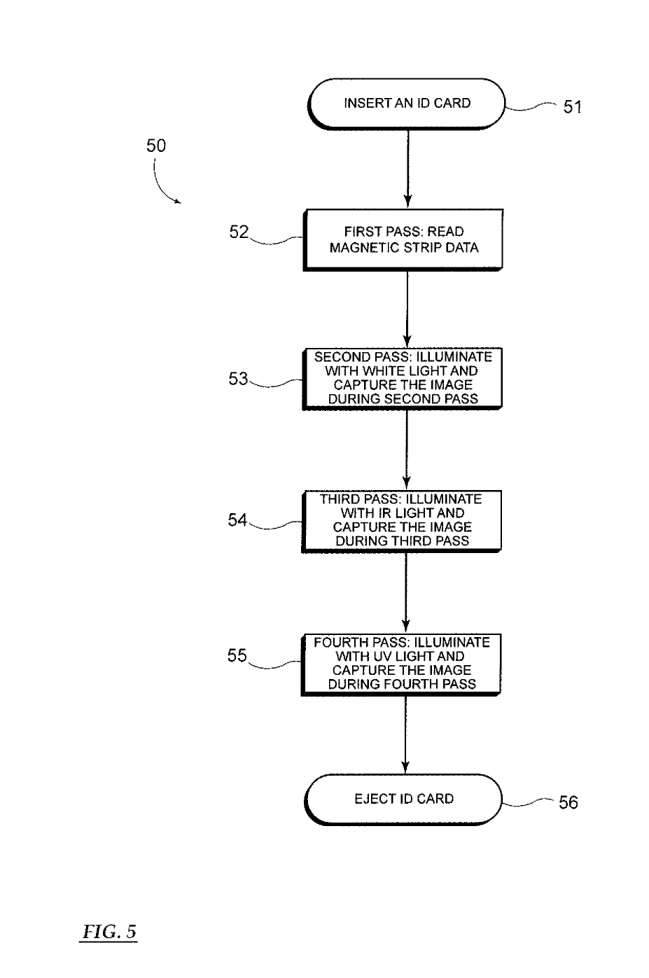

An additional preferred scanning method 40 claimed in the present invention is described in FIG. 4. In a first method step, a document 12 is inserted to the scanning device 11 during an initial pass 41 may capture image and magnetic data 15 from the surface of the document 12. Thus, the initial directional pass may lead to a second pass 419 for the document 12 to capture the required data. If two passes are necessary, the document 12 is translated from a start to an end in a first pass and is translated back in reverse direction in a second pass 419. Additionally, the document 12 may be simply translated through the document scanner 11 for a single first pass only if data captured in one pass is sufficient 419.

The electronic data recorded from the card during initial directional pass 41, which includes magnetic strip 15, RGB or barcode 16, RFID, OCR (Optical Character Recognition, FIGS. 3A and 3B), is transmitted to processor 42 which may be local 13 or networked 14. More particularly, initial processing of recorded data 43 to determine type of the document 12 under review includes decoding of barcode 16 and/or using a pattern recognition method for pictures 17 or other physical or security features by the processor. Optimally, the processor is local 13 or networked 14 to the document scanner 11 and comprises software employed to ascertain any of the following: OCR of the text 18 imprinted on the document 12; electronic information in the magnetic strip 15; and stored in the bar code 16; and electronically capture images from both sides of the document 12 under different light wavelengths to ascertain presence of the required indicia or markings on the document 12. The initial processing of data 43, which includes images, magnetic data, and other information extracted from the document 12, helps in identifying the type of document 12 under review.

Further with regard to FIG. 4, data comprising electronically captured images and electronic information stored in the magnetic strip 15 and bar code 16 are compared 45, 46, with a configured database already stored in the processor 13. If the network is available, the processed data is sent 45 to cloud server 14 as shown in FIG. 2. Where the processor in the scanning system has cloud server functions, the processed data in the cloud server 14 is referenced 45 against a known database of generic information or templates, which contain the information and security features associated with the identified 43 document 12. As a result, the server returns areas 47 of interest for further scanning 48 needed to verify the document 12.

In an additional embodiment, the processor in the scanning system uses host computer 13 as shown in FIG. 2 and in FIG. 4. The processed data is then in the local computer 13 and referenced 46 against the stored database of generic information or templates, which represent the information and security features associated with the identified document 12. As a result, the host computer 13 returns areas of interest 47 for further scanning 49 needed to verify the document 12. If network 14 is not available 45, the processor in the scanning system may also use a high-speed computer 13.

As stated herein, any areas of interest identified by the processor 13, 14 are targeted by additional scans and type of resolution 47. Thus, additional scans are programmable depending upon the type of document 12 and information generated from the processor 13, 14. Such programming of the document scanner 11 enables the end user to decide a number of additional passes required. During additional passes 48 and 410, the end user may further determine to selectively scan any specific area, request to capture particular image 48, to scan under any illumination source, and to maximize the scan resolution of any physical features as required for further processing 412 of the document 12.

As noted, the scanning method of the present invention also provides a maximum resolution 47 of selective scans in order to detect high-resolution features. For example, an embossed print on the document 12 may be magnified up to resolution of 1200 DPI 49 without unacceptably increasing the time to capture the image and/or transfer data to the processor 13. The document scanner 11 can be programmed 49 to vary resolution of each scan of a particular selected area. For instance, the same scan of a same focused area or different scans of different area can be captured in various resolutions in the preferred scanning method.

If necessary, one or more additional passes 410 are made through the document scanner 11. An additional pass through the document scanner 11 may include translating the document 12 for a third pass. Whereas two additional passes may include translating the document 12 for a third pass in forward direction followed by a fourth pass in a reverse direction. The three additional passes may include translating the document 12 for a third pass in one direction followed by a fourth pass in reverse direction, and if intended, the document 12 is translated through the document scanner 11 for a fifth pass.

Additionally according to the method herein, the scanned images and electronic data captured during the entire scanning procedure 40 are transmitted to the local 13 or networked processor 14 for further processing 412. The further processing 412 of additional images could be for archiving purposes by the authorities, authentication of the document being scanned, for comparison of scanned images with the reference document for any purpose intended by the authorities. For instance, the various assembled images captured from additional pass though document scanner 11 may be compared and inspected using software or the human eye on occasions, if the images are simply projected onto a screen to ascertain the authenticity and validity of the any ID card 12, and the authorities may also further access any other useful information about the card holder through the ID card 12.

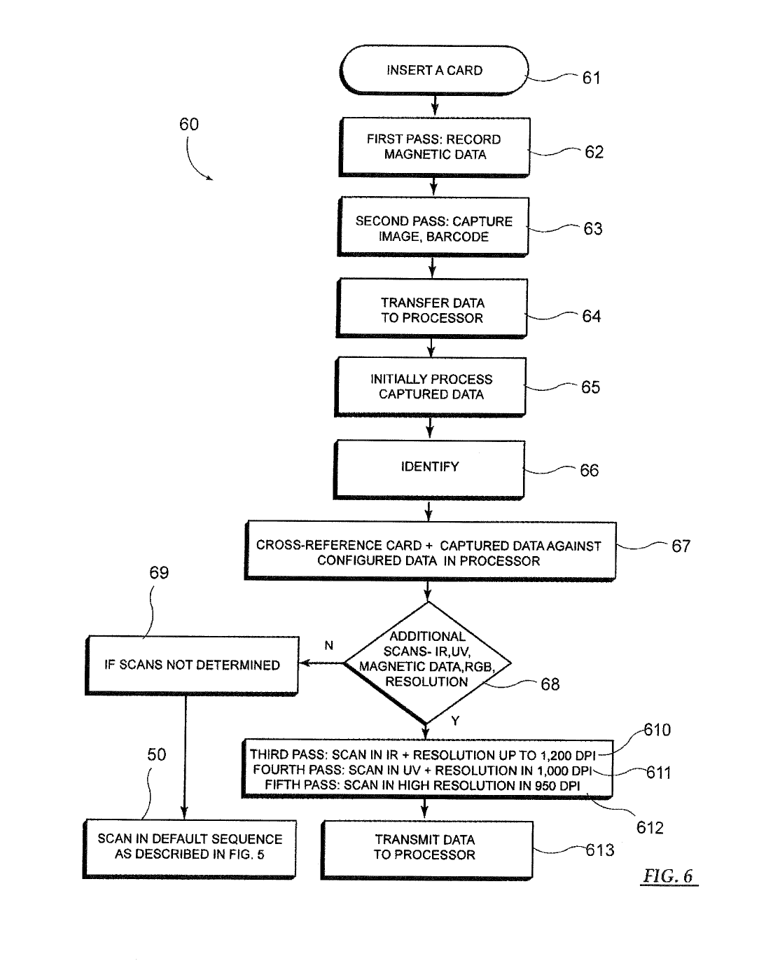

With reference to FIG. 4 and FIG. 6, if during the scanning procedure, it is determined that no selective scanning would be necessary, the document scanner 11 can be adapted to scan the document 12 in a default scanning process 50 as described in FIG. 5 wherein the document 12 is translated through the scanning device 11 to capture additional images 52, 53, 54, 55 under various light sources in additional passes.

FIG. 5 describes the entire default scanning method 50 in the event that the end user decides at the start of the scanning method, that no selective scanning is required. Initially, the ID card 12 in inserted 51 and the document scanner 11 reads the magnetic strip data 15 of the card 12 in a first pass 52. In a second pass 53, card 12 is illuminated with white light to capture an image (for e.g. RGB) or barcode 16. During a third pass 54, the card 12 can be illuminated with a first light source (e.g. IR) and the image is captured and stored in the memory. Subsequently, the document scanner 11 mechanically translates the card 12 in a reverse direction for a fourth pass 55. During a fourth pass 55, the card 12 is illuminated with a second light source (e.g. UV) and an image is captured and stored to the memory before being translated before exiting the document scanner 11. However, the default scanning method may still be programmed with respect to light sources. For instance, the first and second light source could be a specific frequency of light, or any other combination of simultaneous light frequencies.

If the document scanner 11 fails to capture and record electronic data and images in the initial pass, it may still employ default method 50 and continue to scan additional images 52, 53, 54, 55 under various light sources during additional passes. For instance, the document 12 can be mechanically translated through the document scanner 11 for a third pass 54 under one light source followed by a fourth pass 55 in a same or different illumination source.

In an illustrated embodiment, the present invention is demonstrated using an E-SEEK scanner Model M500 to capture images in full Duplex format. The M500, a sophisticated scanning device, is capable of scanning an ID card 12 in different light sources on each scanning passes. The proposed adaptive scanning method 60 starts with scanning the magnetic strip 15 on first pass 62 through the document scanner 11. It 60 then captures RGB (using a white light) on a second pass 63 through the document scanner 11. The said second pass 63 will be able to capture the data on the card 12 in a 600 DPI resolution. Also, while the document scanner 11 is scanning the ID card 12 during the second pass 63, it will transfer the data captured 64 from the card 12 to a local computer 13. Such transfer of data 64 during scanning allows the local computer 13 to initiate the process to locate and decode any barcodes 16 present on the card 12. Also, the local computer 13 could compress the image of the card 12 in 4:1 and store it with the purpose of processing it in the future, if need arises. The recorded data from the magnetic strip 15 along with bar code 16 and any digital image, if taken, is transferred to the local computer 13 for the initial electronic processing 65 of the data captured 62, 63 from surface of the card 12.

During the initial electronic processing 65, the processor decodes the bar code 16 and performs pattern recognition method for other images. The information extracted after decoding the bar code 16 and pattern recognition method along with data obtained from the magnetic strip 15 of the card 12 are used in determining a type 66 of card 12.

Subsequent to identifying 66 the type of card 12, the processor performs a fast reference check 67 of the recorded data from the card 12 against a configuration data in the processor. Such reference checks determine additional scans 68 for further scanning 610, 611, 612 and processing 613 and accordingly list tasks for the document scanner 11. Examples of additional scans 68 include but not limited to IR scan, UV scan or any other light source wavelength scan, magnetic strip 15 scan, RGB scan, OCR scan, RFID scan, and/or high resolution scans of any of these abovementioned scans or any other area up to 1200 DPI. The document scanner 11 is programmed according to the selected additional scans 68, and the card 12 is translated in additional passes through the document scanner 11. During a third pass 610, the card 12 is scanned under IR light and the resulting scan is maximized to a resolution of 1200 DPI. In a fourth pass 611, the card 12 is scanned under UV light and the resulting scan image is maximized to a resolution of 1000 DPI. In a fifth pass 612, a particular area of the card 12 is scanned in high resolution 1200 DPI. The additional images and data obtained from additional passes are transmitted to the processor for further processing 613 like authentication of the card 12.

While many of the fundamental characteristics and features of the scanning system and its methods have been described herein, with reference to particular embodiments thereof, a latitude of modification, various changes and substitutions are intended in the foregoing disclosure, and it should be apparent that in some instances some features of the invention will be employed without a corresponding use of other features without departing from the scope of the invention as set forth. It should be understood that such substitutions, modifications, and variation may be made by those skilled in the art without departing from the spirit and scope of the invention. Consequently, all such modifications and variations are included within the scope of the invention as defined herein.

What is claimed is:

1. An adaptive scanning method for reading and processing a document comprising:
capturing electronic data from a surface of said document in a document scanner on an initial pass;
initial processing the electronic data recorded on said initial pass to a processor;
parsing said electronic data to a first configuration data stored in said processor to determine a second configuration data for selective processing of said document; said selective processing of said document comprising:
transmitting said second configuration data from said processor to said document scanner, the second configuration data comprising a desired selective image on said document for subsequent scanning;
automatically configuring said document scanner for capturing of the selective image of said document in said document scanner during an additional pass; and
transmitting the selective image during said additional pass back to said processor; said processor further including software adapted to further process said document using said electronic data captured during said initial pass, together with the selective image captured during said additional pass.

2. The adaptive scanning method of claim 1, wherein said electronic data captured from surface of said document during said initial pass includes magnetic data from a magnetic strip, an Optical Character Recognition of text, a logo, data stored on a solid state device, a barcode and a microprint.

3. The adaptive scanning method of claim 1, wherein said electronic data captured from a surface of said document during said initial pass further includes scanning of said document under a light source having one or more wavelengths of light.

4. The adaptive scanning method of claim 3, wherein said light source is selected from a group of UV (365 nm), Blue (470 nm), Green (525 nm), Red (625 nm), IR (850 nm) and white.

5. The adaptive scanning method of claim 1, wherein said initial pass includes translating said document through said document scanner in a first pass in a first direction followed by a second pass in a reverse direction.

6. The adaptive scanning method of claim 1, said initial processing of transferred electronic data further comprising:
extracting and decoding a barcode; and
recognizing a pattern of physical features embossed on said document.

7. The adaptive scanning method of claim 1, the selective image captured during said additional pass further comprising:
a specific location on said document;
a specific light source; and
a resolution.

8. The adaptive scanning method of claim 1, wherein said selective image comprises a scan of a half of said document under one light source and a second half under a different light source.

9. An adaptive scanning method for reading and processing a document comprising:
recording electronic data from a surface of said document in a document scanner on a first pass;
scanning said document to digitally record an image during a second pass;
transferring electronic data recorded on said first pass and said second pass to a processor;
initial processing of transferred electronic data captured from said document in said processor to identify a type of said document; and
parsing said processed electronic data to a first configuration data stored in said processor, said processing for determining a second configuration data for selective processing of said document; said selective processing of said document comprising:
transmitting said second configuration data from said processor to said document scanner to capture selective images for said document based on the second configuration data;
configuring said document scanner for capturing of selective images for said document in said document scanner during a third pass and a fourth pass; and
transmitting said selective images from said third pass and said fourth pass back to said processor; said processor further having software adapted to further process and authenticate said document with said electronic data captured from said first and said second pass, and said selective images captured from said third pass and said fourth pass.

10. The adaptive scanning method of claim 9, wherein the electronic data captured from surface of said document during said second pass includes Optical Character Recognition of texts, a logo, and a barcode.

11. The adaptive scanning method of claim 9, wherein said initial processing of transferred electronic data comprises extracting and decoding the barcode and pattern recognition method of physical features embossed on said document.

12. An adaptive scanning method for fast authentication of an identification card, the method comprising:
determining the type of identification card presented to document scanner;
targeting specifically a selective area;
determining a configuration data to extract from the selective area for selective scanning;
scanning the selective area using a specific light source, the specific light source depending on the configuration data in the selective area; and
processing scanned data of said selective area to authenticate the ID card.
